(19) United States
(12) Patent Application Publication
(10) Pub. No.: US 2015/0064644 A1
(43) Pub. Date: Mar. 5, 2015

(54) Method for Using Radiopaque Dental Impression Material

(71) Applicant: Michael David Scherer, Sonora, CA (US)

(72) Inventor: Michael David Scherer, Sonora, CA (US)

(21) Appl. No.: 14/474,071

(22) Filed: Aug. 29, 2014

Related U.S. Application Data
(60) Provisional application No. 61/871,823, filed on Aug. 29, 2013.

(51) Int. Cl. A61C 9/00; A61C 13/01

(52) U.S. Cl. CPC A61C 9/0006; A61C 9/004; A61C 13/01
USPC 433/29; 433/213

(57) ABSTRACT

The invention could be a method of operating a scanning dental combination comprising the following steps, providing a prosthesis device having an artificial base supporting one or more artificial teeth; providing a radiopaque dental impression material that can form a physical impression of a portion of a mouth of patient, the portion of a mouth of patient being used to support the dental prosthesis device; using the radiopaque dental impression material to make an impression of the portion of the mouth of the patient; forming a combination of the radiographic dental impression material and dental prosthesis device; and scanning the combination with a radiographic scanning machine to create at least one digital file of a radiographic-based image of the combination.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to dental scanning methods that may involve scanning of a dental prosthesis device and the scanning of one or more portions of the patient's mouth used to support said dental prosthesis device. More specifically, the present invention may related to those dental scanning methods that may involve scanning a combination of radiopaque dental impression material and dental prosthesis device.

### BACKGROUND

Traditional dental modeling techniques have involved mechanical methods such making a dental prosthesis device (e.g., a denture or its duplicate/model) as well as an impression of the patient's mouth. The impression may then be used to creating a resulting casting(s) (e.g., model[s] of at least a portion of the patient mouth) demonstrating where the dental prosthesis device is generally to be placed in the patient's mouth. The casting or castings may then be placed in support mechanism such as an articulator, which can duplicate the hinge action of the jaw. The placement of the dental prosthesis device upon the casting(s) so held can allow the dental professional proceed with a wide variety of dental procedures from adjusting the fit of the dental prosthesis device to creating a dental surgical implant plan for attaching the dental prosthesis device to the mouth to fabricating a new dental prosthesis device and the like.

As the dental profession generally progresses and increases its computerized capability, such mechanical dental modeling techniques are being supplanted with scanning techniques combined with digital-based imaging, planning and fabrication. Scanning technologies may include but are not limited to radiographic scanning capabilities such as cone-beam computerized tomography (CBCT), computerized axial tomography (CAT), magnetic resonance imaging (MRI). These scanning technologies can suitably “map” the scanned item and create a data file that can be subsequently manipulated by appropriate digital imaging software to produce a virtual three dimensional image of the item and can be superimposed on other such images of other objects to create a virtual model of an multi-object combination (e.g., create a virtual model of the patient's mouth containing the placed dental prosthesis device.) The virtual three dimensional model can then further used in dental planning and fabrication (e.g., substantially creating dental surgical plans, dental prosthesis devices, dental surgical guides and other dental implements/prostheses that may be used in dental reconstruction or enhancement fields.)

One current method of imputing existing dental prosthesis devices into a scan data file mat require that the dental prosthesis device (e.g., the actual prosthesis or its duplicate/model) be altered so that radiographic makers (e.g., spheres or plastic-coated spheres of radiopaque material [e.g., various metals that can deflect x-rays and other forms of electromagnetic radiation used by the scanning devices] can be attached or embedded into the dental prosthesis device. Such actions on the actual dental prosthesis device could be considered destructible and generally render the actual dental prosthesis device un-suitable for patient's future use. These attached radiopaque materials act as registers so that when the dental prosthesis device so modified is subsequently scanned, the reflections of the attached radiopaque material, when the scanning data file is processed by the modeling software system, the reflections can be matched up with previously inputted register values to allow scan image to be manipulated and overlaid upon other scan images (e.g., the castings) that also share common inputted registered values (e.g., also have been affixed with radiopaque markers and the like.)

This scanning/modeling method may been seen as having limitations that add to the expense and time required by the scanning/modeling method. These limitation may be seen as requiring the manufacture and use of the model or duplicate for such duties; the continued use of scanning castings instead of scanning the patients mouth directly thus introducing additional steps in the process that repeat, enhance and compound errors in the scanning and modeling phases; the scanned castings may not present a complete radiographic visualization of the prosthesis bearing surface (e.g., not being able to showing interior structure of the tissue/gums.); inadequate digital overlaying of a casting or replica of the prosthesis bearing surface with other desired scanned images that are not to allow the subsequent planning and fabrication of a dental implements (e.g., dental prosthetics, surgical guides, and the like.) that can be used in surgical reconstruction or enhancement of the prosthesis bearing surface; and the like.

What could needed therefore is a dental scanning method substantially comprising of the steps of substantially applying radiopaque dental impression material to the dental prosthesis device; generally applying the combination of radiopaque dental impression material and dental prosthesis device to the patient; substantially allowing the radiopaque dental impression material to solidify in place upon the patient; generally scanning the combination intraorally within the patient; substantially removing the combination from the patient and subsequently generally scanning removed combination.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to scan a combination of a dental prosthesis device, a radiopaque dental impression material, and tissue/tooth bearing surface to create a digital visualization using dental modeling software, the digital visualization being subsequently using to help provide subsequent dental planning and fabrication;

provide a dental scanning method that allows the virtual modeling software capability to to digitally register tissue/tooth bearing surfaces for digital visualization substantially for the purposes of radiographic interpretation, dental prosthetics, dental surgical planning, and dental implement fabrication, and the like;

the ability to utilize an existing dental prosthesis device (e.g., existing prosthesis or model or duplicate of same, trial prosthesis, wash illumination and the like) to combined with a silicone, methacrylate reline, or zinc-oxide material incorporating a radiographic opaque capability, the material being placed on a surface of a prosthesis device and placing the material-dental prosthesis device combination intraorally to register tissue/tooth bearing surfaces, neither the material application to nor the subsequent material removal from the device does not permanently altering the structure of the prosthesis device;

to provide a dental scanning method that can apply and remove a radiopaque material to a prosthesis without causing a degradation of the prosthesis, the combination of radiopaque material and prosthesis being placed intraorally and subsequently scanned;

the ability to combine the radiographic information with greater virtual visual resolution using direct/indirect digitized scans of the tissue/tooth bearing surfaces; and

to provide data information obtained from the scanning a dental prosthesis device, radiopaque impression material, and tissue/tooth bearing surfaces to virtually plan and fabricate a dental implements/prosthetics and the like.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a dental radiographic scanning combination comprising a dental prosthesis device having one or more artificial teeth supported to by an artificial base, a part of the artificial base being capable of receiving a portion of a mouth of a patient; a radiopaque dental impression material being capable of creating a physical impression of the portion of the mouth of the patient, the radiopaque dental impression material removably attaches to the dental prosthesis device, the radiopaque dental impression material forms an impression by being sandwiched between the dental prosthesis device and the portion of the mouth of the patient; and a scanning device that performs a scan of the dental prosthesis device and the radiopaque dental material together to create a data file of an image of the dental prosthesis device and radiopaque dental material together.

Another possible embodiment of the invention could a method of operating a scanning dental combination comprising the following steps, providing a prosthesis device having an artificial base supporting one or more artificial teeth; providing a radiopaque dental impression material that can form a physical impression of a portion of a mouth of a patient, the portion of a mouth of patient being used to support the dental prosthesis device; using the radiopaque dental impression material to make an impression of the portion of the mouth of the patient; forming a combination of the radiopaque dental impression material and dental prosthesis device; and scanning the combination with a radiographic scanning machine to create at least one digital file of a radiographic-based image of the combination.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention to is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially showing a perspective partial cutaway view of one embodiment of the dental scanning combination of the present invention.

FIG. 2 is substantially showing a perspective view of another embodiment of the dental scanning combination of the present invention.

FIG. 3 is substantially a perspective, partial cutaway view of one embodiment of the dental prosthesis device of the present invention.

FIG. 4 is substantially a perspective, underside view of one embodiment of the dental prosthesis device of the present invention.

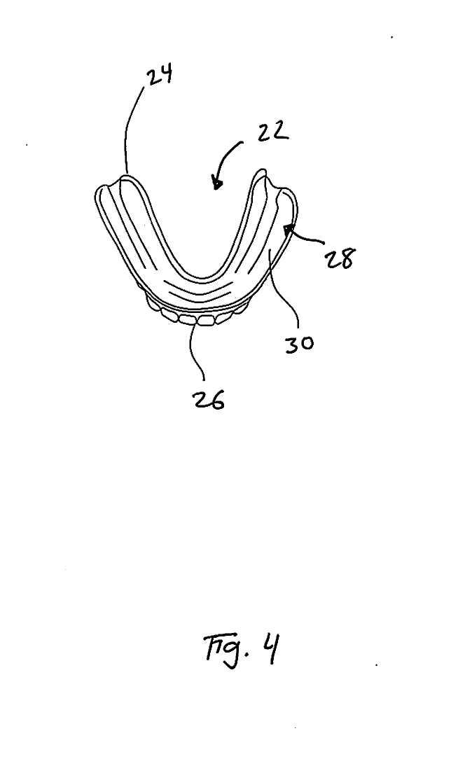

FIG. 5 is substantially showing an overhead view of a pallet supported pre-mixed component form of the dental impression material.

FIG. 6 is substantially showing a perspective view of the mixing of the components to form the dental impression material.

FIG. 7 is substantially showing a perspective view of the operator applying the dental impression material to the underside of the dental prosthesis device.

FIG. 8 is substantially showing a prepositive view of the intraoral placement of the dental prosthesis device and dental impression material upon the portion of the mouth of the patient.

FIG. 9 is substantially showing a flowchart schematic showing one possible embodiment of the method.

FIG. 10 is substantially showing an overhead perspective view of the non-radiopaque spacers being applied to the mouth of the patient to prevent unwanted contact by various mouth tissues and teeth to the external surface of the dental prosthesis device.

FIG. 11 is substantially showing a side perspective view of the non-radiopaque spacers being applied to the mouth of the patient to prevent unwanted contact by various mouth tissues and teeth to the external surface of the dental prosthesis device.

FIG. 12 is substantially showing one embodiment of the dental scanning combination.

FIG. 13 is substantially showing another embodiment of the dental scanning combination.

FIG. 14 is substantially showing a graphic schematic view showing the virtual modeling of the obtained scans to provide planning and fabrication of dental implements, dental prosthetics and the like.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

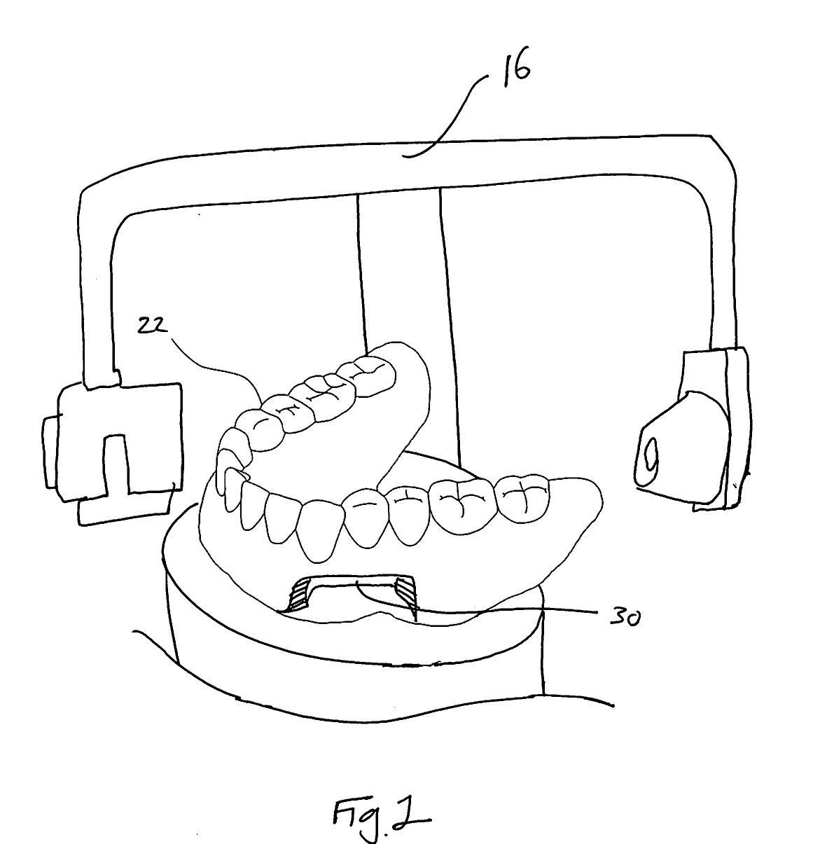

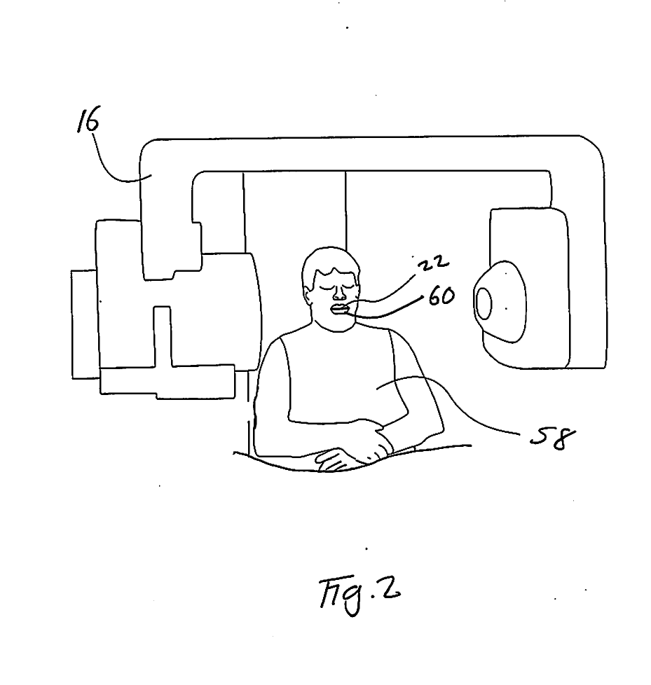

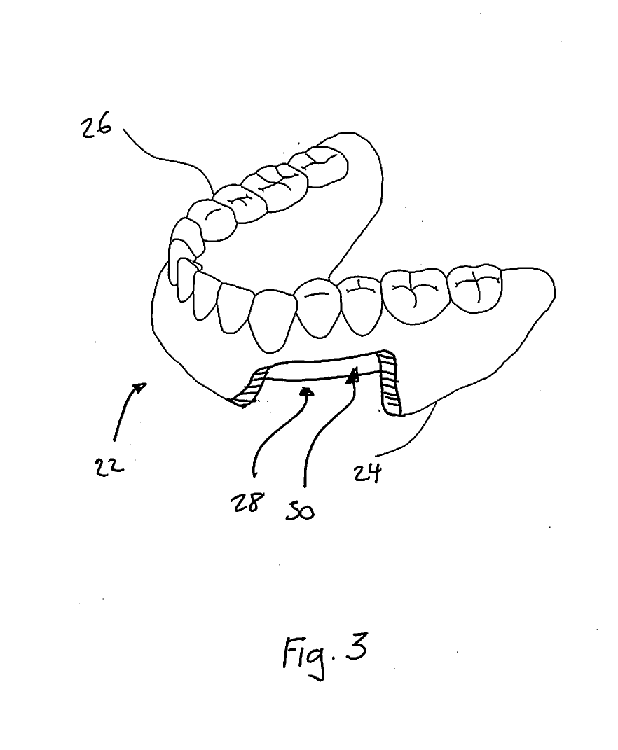

The present invention 10 could comprise a dental radiographic scanning combination 20 and a method of operating a scanning dental combination 100 for enhanced radiographic interpretation, dental surgical planning and dental implement/prothesis fabrication. As shown in FIG. 1, the dental scanning combination 20 could comprise a dental prosthesis device 22, radiopaque dental impression material 30 that can be used to create an impression, and a scanning device (e.g., radiographic and non-radiographic). As substantially shown in FIGS. 2 and 3, other embodiments of the dental scanning combination 20 could further comprise a patient 58, more specifically a portion of a mouth of a patient 60 that can interact (e.g. support, attach to) with the dental prosthesis device 22. As substantially shown in FIG. 3, the dental prosthesis device 22 could be a complete or full plate denture (shown), a partial denture, or a radiographic denture/partial duplicate temple. The dental prosthesis device 22 could be a duplicate/model prosthesis that is substantially only employed for the purposes of radiographic interpretation; the patient's existing prosthesis; trial prosthesis, wash impression, a newly created prosthesis or the like. The dental prosthesis device 22 could be constructed to provide an appearance and a general functioning of one or more lost teeth for a patient. The dental prosthesis device 22 could generally comprise an artificial base 24 supporting one or more artificial teeth 26, the artificial base 24 generally having a underside 28 that can interact with and be supported by the portion of the mouth of the patient 60 (e.g., base's underside could have an channel 30 that opens out and generally receives the portion of the mouth of the patient 66, the one or more contours of the channel 30 may match one or more the exterior contours of the portion of the mouth of the patient 66.)

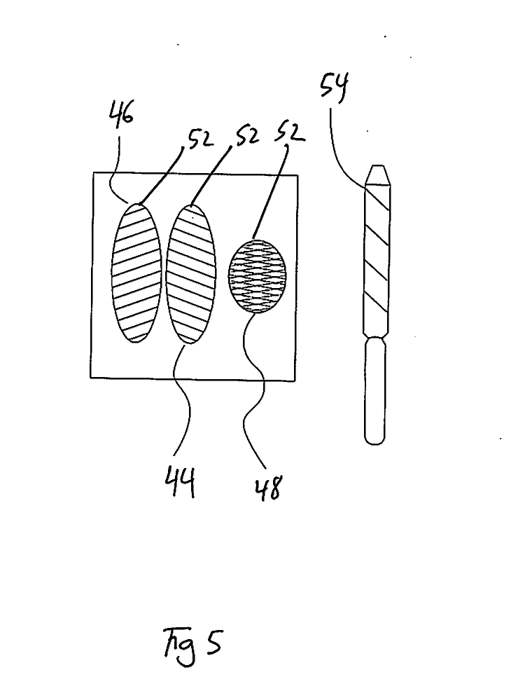

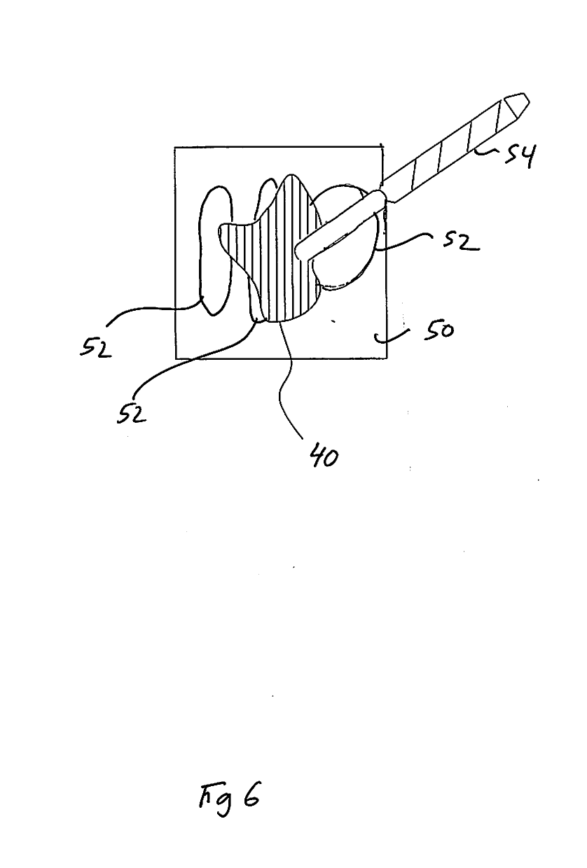

As substantially shown in FIGS. 5 and 6, the dental impression material 40 that can be used to create an impression could comprise of a material base 42 that could be combined with radiopaque material 46 to form the dental impression material 40. A hardening or polymerizing catalyst 48 could be used to change the material base's gel or jelly-like initial consistency to a harder consistency (e.g., rubber, plaster or the like.) In one embodiment, the dental impression material 42 could be provided upon a pallet 50 in component format, the pallet 50 having a set of receptacles or grooves 52 in which could respectively hold the hardening catalyst 48, the material base 44 and the radiopaque material 46. The pallet 50 could sealed with a removable plastic cover (not shown) and be provided with a spatula 54 for mixing the components and applying the resulting dental impression material 40 to the dental prosthesis device 22 (e.g., applying to the channel 30).

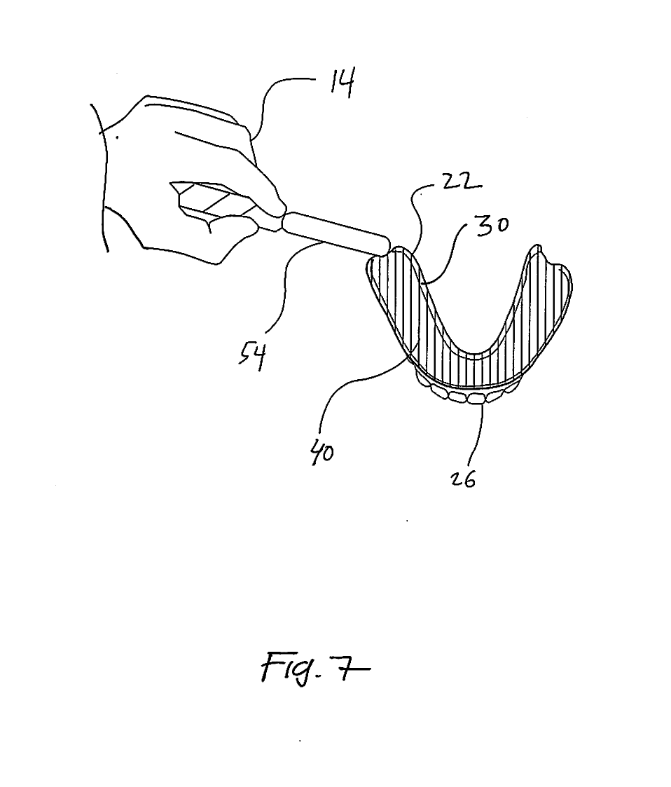

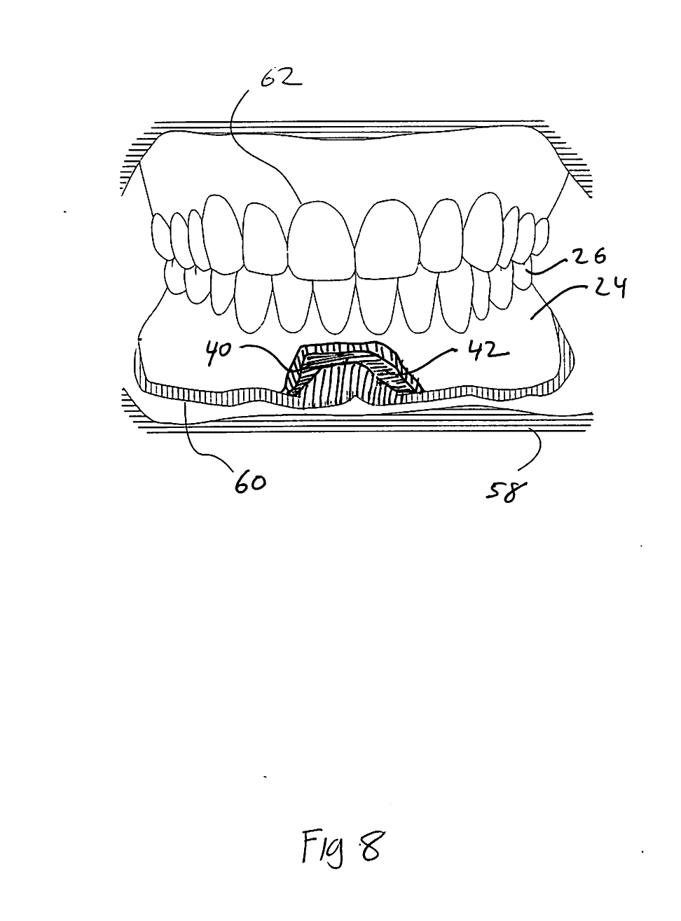

As substantially shown in FIGS. 6, 7 and 8 in operation, the removable plastic cover (not shown) is removed, the operator (e.g., a dental health care professional or the like) 14 uses the spatula 54 to mix together the appropriate dental impression material components (e.g., catalyst 48 [as needed], material base 44, radiopaque material 46) together to form the dental impression material 40. The operator 14 can then apply the dental impression material while still in its initial consistency (e.g., gel to jelly-like consistency) to the dental prosthesis device 22 (e.g., to the channel 30.) The operator 14 can then take and apply the dental prosthesis device 22 and dental impression material as combined intraorally to patient 58, more specifically to the portion of the mouth of the patient 60 (e.g., the teeth and/or tissue portion of the patient's mouth that may support the dental prosthesis device 22.) In this manner, the dental impression material 40 may be sandwiched under compression between the portion of the mouth of the patient 60 and dental prosthesis device 22. When the fixation (e.g., hardening) of the dental impression material 22 has been substantially completed, the operator 14 may check the fit of the dental prosthesis device 22/dental impression material 40 combination to the portion of the mouth of the patient 60 (that may be used to secure or support the dental prosthesis device 22) to generally ensure that the impression 42 as formed by dental impression material 40 has adequately captured the contours of the said portion of the mouth of the patient 60. If the capture is not adequate, the radiopaque dental impression material 40 can be removed from dental prosthesis to device 22 (the new radiopaque dental impression material 40 can be obtained (e.g., prepared) and be reapplied to the dental prosthesis device 22 to reform the dental scanning subject combination when reapplied to the portion of the mouth. In this manner, the dental impression material 40 may be applied and removed from the dental prosthesis device 22 without permanently altering the structure of the dental prosthesis device 22.

In one embodiment, the material base 44 could be a silicone impression material, a silicone disclosing agent, a methacrylate-based denture/partial reline material, zinc-oxide eugenol impression or liner material, or the like. These material bases 44 may be further mixed with a catalyst or hardening agent 48 to change the initial generally gel or jelly-like consistency of the material base 44 to a more firm consistency that may be comparable to the hardness of rubber, plaster or the like. One possible version of the silicone impression material so used could be a dental impression polymer (e.g., Blu-mousse®, Green-mousse®, Parkell, Inc. 300 Executive Drive, Edgewood, N.Y. 11717 USA) that has an initial consistency of jelly, to which a hardening agent 48 can be added that upon fixation gives a consistency of rubber (i.e., 60-udometer.) It should be noted that other suitable material bases 44 that have built-in hardening agents/catalysts, which are activated when the material base is exposed to air, electromagnetic radiation (e.g., UV light) and the like. One or more material bases could be made with radiopaque capabilities.

The radiopaque material 46 could selected from a group of radiopaque materials comprising of powders of metals aluminum, ytterbium, itrium, gadolinium, zirconium, strontium, tungsten, tantalum, niobium, bismuth, molybdenum and lanthanum, powders/suspensions of barium, or powders/suspensions of barium mixed with powders/suspensions of methacrylate-based materials, powders of alloys thereof, oxides, fluorides, sulfates, carbonates, tungstates and carbides thereof.

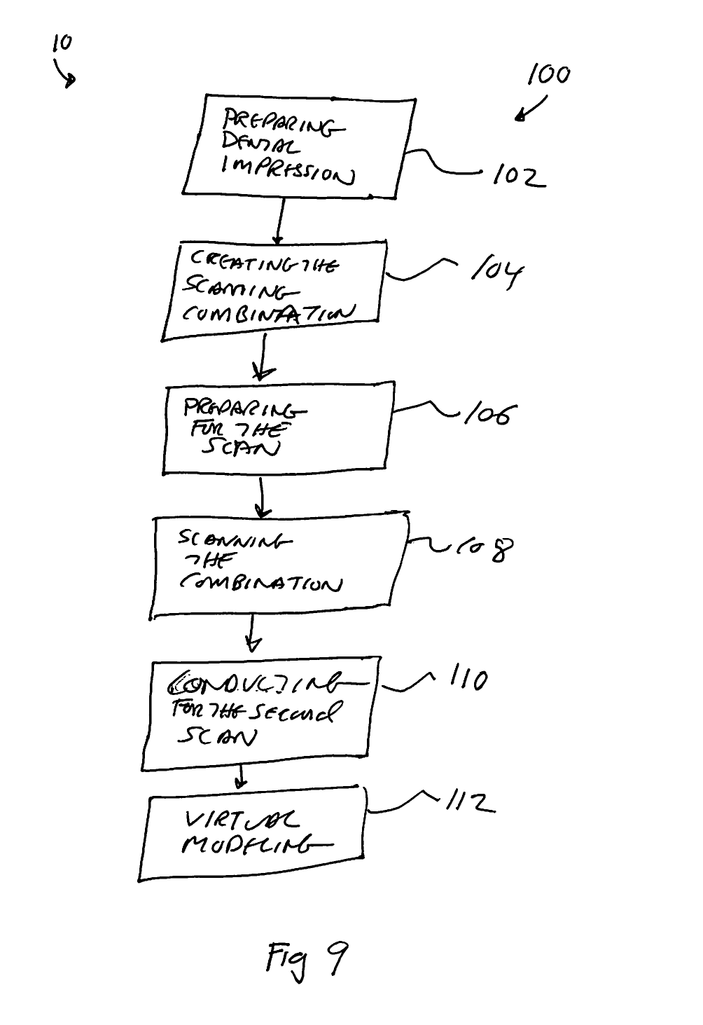

As substantially shown in FIG. 9, the method or process for operating a dental scanning subject combination 100 could start with step 102, preparing the dental impression material. In this step, the dental prosthesis device could be dried (to ensure a proper attachment of the radiopaque dental impression material to the dental prosthesis device.) The dental impression material could be procured (e.g., the components [e.g., radiopaque material, material base, catalyst] are suitably mixed.) As this step is substantially completed, the process 100 can proceed to step 104, creating the combination.

In step 104, creating the scanning combination, the dental impression material could be applied to dental prosthesis device (e.g., applied to the channel) in a suitable quantity and manner that dental impression material can fill any voids between the mouth portion and the dental prosthesis device. The patient may then close his or her mouth down upon dental prosthesis device, compacting the sandwiched dental impression material in a manner that generally ensures that the dental impression material moves or flows into the voids or vacancies between the dental prosthesis device and the portion of the mouth of the patient to make a detailed and accurate impression of the desired mouth portion. As this step is substantially completed, the method 100 could proceed to step 106, preparing for the scan.

In step 106, preparing for the scan, the patient may relax and open the mouth, generally removing the opposing alveolar ridge from contact with the dental prosthesis device. The operator may inspect the formed impression made by the scanning combination (e.g., remove the combination of the dental prosthesis device and dental impression material from the mouth of the patient.) After completing a satisfactory inspection, the dental prosthesis device/dental impression material combination may then be appropriately replaced upon the mouth portion to reconstitute the dental scanning subject combination.

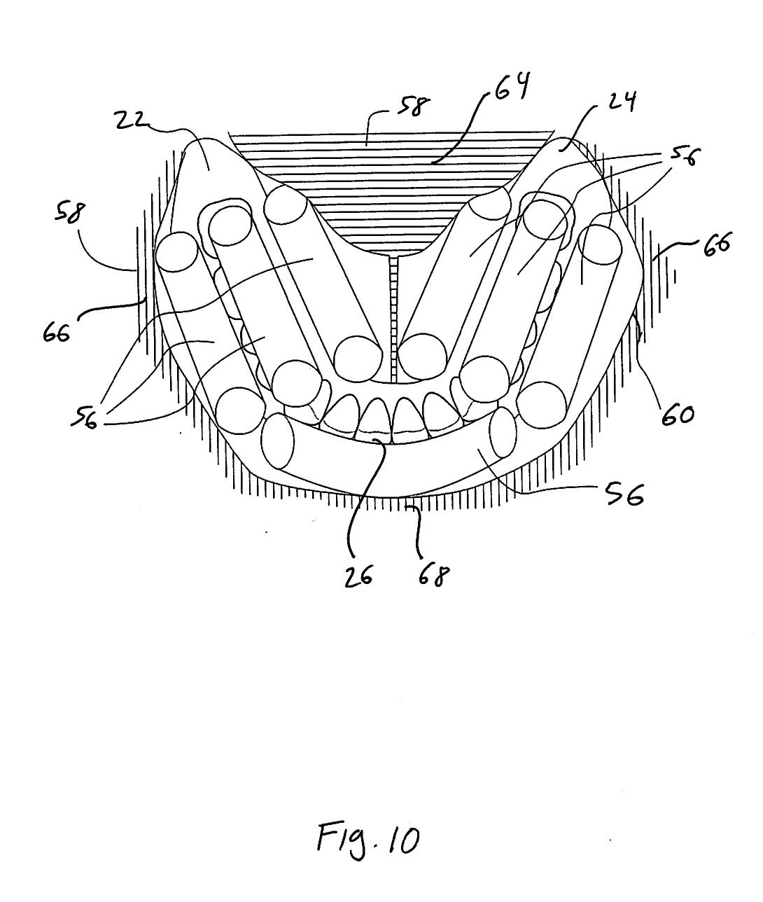

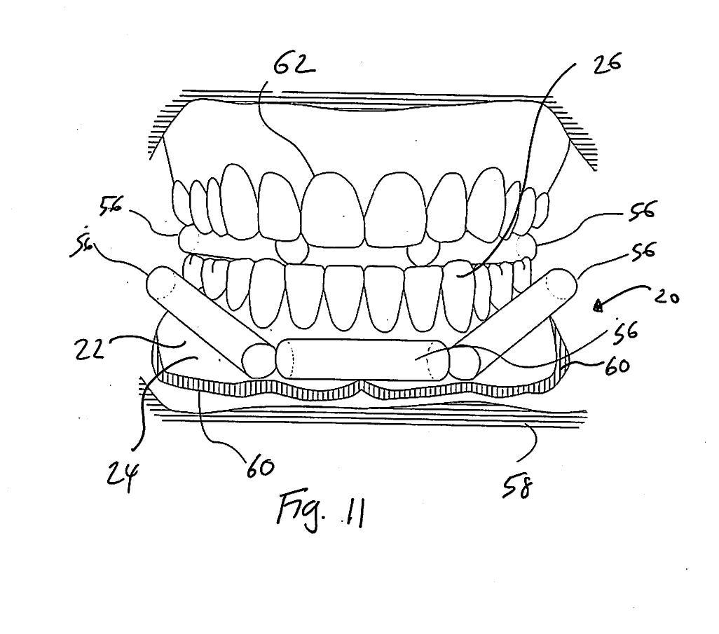

As substantially shown in FIGS. 10 and 11, the operator may then place generally non-radiopaque spacing material 56 (e.g., cotton rolls, cotton gauze or the like) to prevent contact by the dental prosthesis device 22 (e.g., artificial teeth 26, artificial base 28) with the opposing alveolar ridge 62 and other mouth tissues (e.g., tongue 64, cheeks 66, lips 68 and the like.) The radiographic signatures of the opposing alveolar ridge 62 and other mouth tissues which can be very confusingly similar to the ones produced in relation to the dental prosthesis device. As such by avoiding this kind of contact, the radiographic signatures of the opposing alveolar ridge and other mouth tissues will not overlap and obscure the radiographic signatures of the dental scanning subject combination. This separation could allow resulting virtual imagery of the dental subject combination 20 to have greater clarity in regards to combination's features.

As this step is substantially completed, the method 100 may proceed to step 108, scanning the combination.

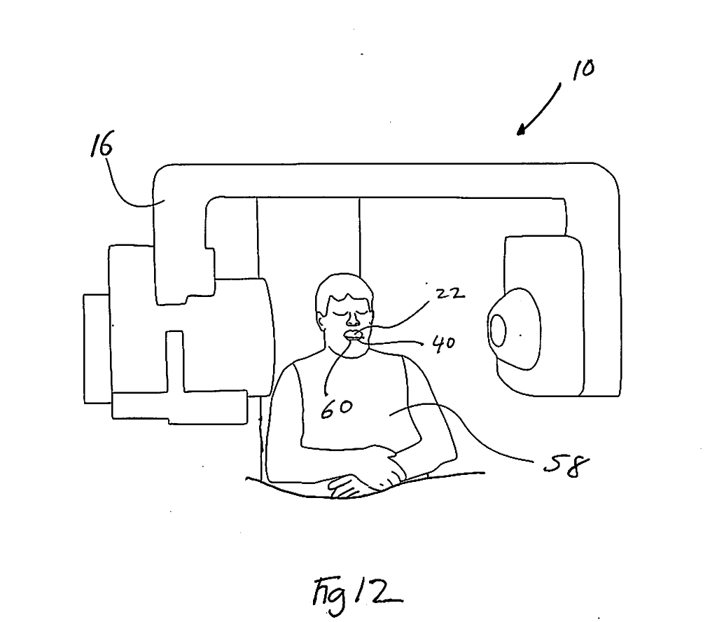

In step 108, as substantially shown in FIG. 12, scanning the dental scanning subject combination, the scanner 16 can be one of a variety of radiographic scanning capabilities (e.g., a cone-beam computerized tomography (CBCT), computerized axial tomography (CAT) Scan, or magnetic resonance imaging (MRI) scan, and the like) may be used to scan the dental scanning subject combination while located intraorally within the patient. The scanning device can create one or more data files of the recorded imaging of the dental scanning subject combination, and in particular of the imaging created of the dental impression material impression made of the mouth portion.

Upon substantial completion of this step, the process 100 could continue onto step 110, conducting the second scan.

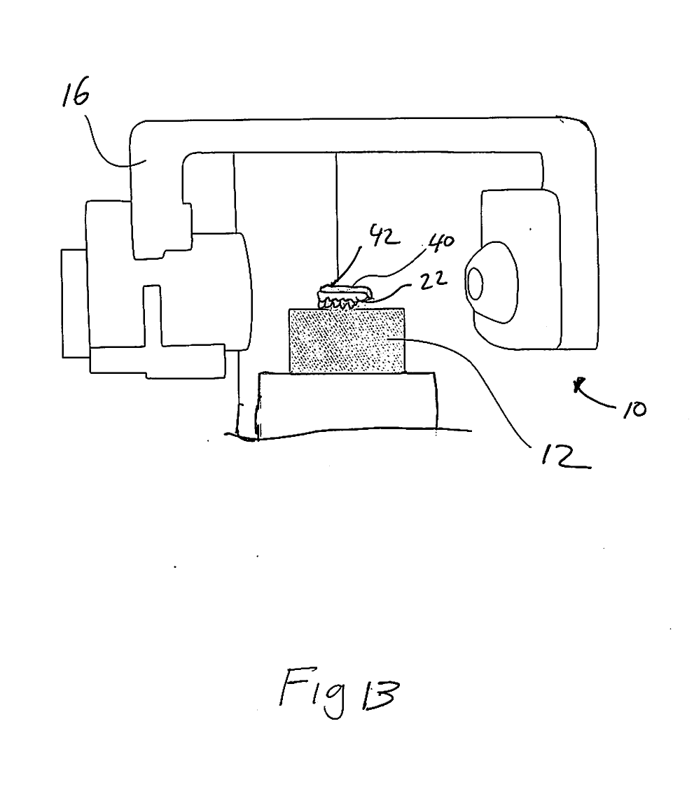

In step 110, conducting for the second scan, as substantially shown in FIG. 13, the operator can remove any non-radiopaque spacing material from the patient's mouth. The dental prosthesis device/dental impression material combination can be removed from the patient's to mouth. The dental prosthesis device 22/dental impression material 40 combination can be placed upon a non-radiopaque material 12 (e.g., a polystyrene foam box) that is further placed upon a support structure so that combined dental prosthesis device 22/dental impression material 40, especially the form impression 42, can be placed in a raised position to be scanned by the scanner 16. The scanner 16 again could be one of a variety of radiographic scanning capabilities (e.g., a cone-beam computerized tomography (CBCT), computerized axial tomography (CAT) Scan, or magnetic resonance imaging (MRI) scan, and the like) may be used to scan the dental prosthesis device 22/dental impression material 40 combination. The scanner 16 could scan the dental prosthesis device 22/dental impression material 40 combination to create one or more data files of the recorded imaging of the dental scanning subject combination, and in particular of the imaging created of the dental prosthesis device/dental impression material combination. It should be noted in both scans, the formed impression 42 of the radiopaque dental impression material 42 (and hence the surface of the portion of the mouth can be suitably imaged and recorded by both scanning devices in the created data files.) In other embodiments of the invention 10 could use scans of the various combinations using other scanning means to the scans as described above to create data files to be used in later modeling processing steps.

As this step is substantially completed, the method 100 could continue to step 112, virtual modeling.

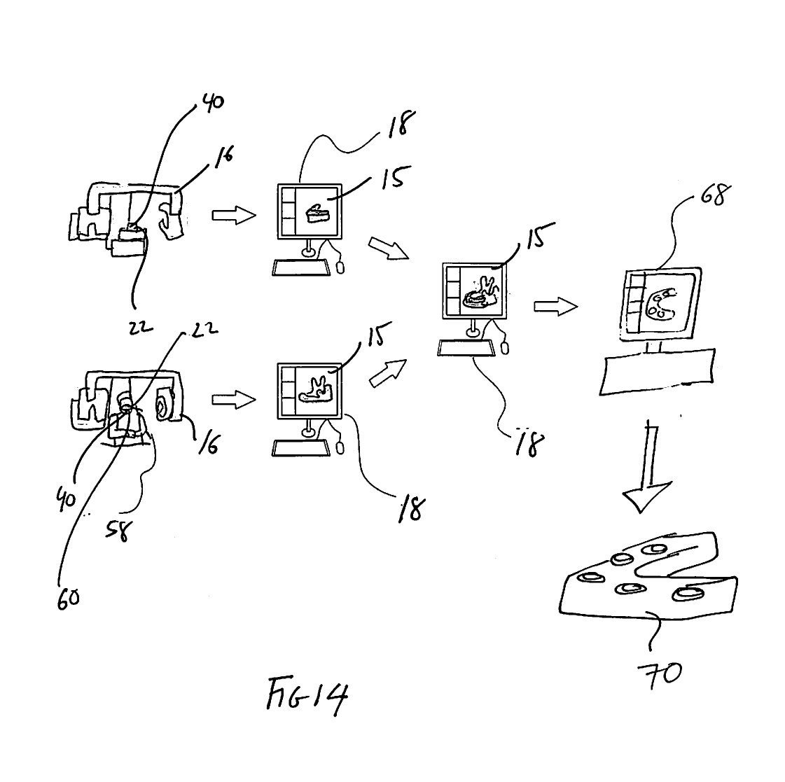

In step 112, virtual modeling, as substantially shown in FIG. 14, DICOM (Digital Imaging and Commination in Medicine)) based virtual model imaging software hosted upon a computer system 18 (e.g., server with suitable user interface[s] and memory/processing capability and the like) that can be used to process data files inputted into it from the scanning devices 16 where the creation of a visual three dimensional model 15 of the bearing surfaces of the mouth portions may occur utilizing and aligning (based on digital registration-rather that radiographic based-registration means) the two scans (the direct scan and the indirect scan of the mouth portion.) Once the virtual model 15 is created, it may be subsequently used to create data that may be used with additional digital planning and digital fabrication capabilities to create dental surgical plans, dental implements 70, dental prosthetics, dental guides and the like. In one instance, not shown, the invention 10 may allow a filler to be created that fills a void(s) as demonstrated by the impression between the underside of the dental prosthesis device and the portion of the mouth of the patient, the filler may be subsequently attached to the underside of the dental prosthetic device to illuminate such voids and provide a better fit between the dental prosthesis device and the patient.

Upon substantial competition of this step the process 100 can return to step 102 for use on other dental prosthesis devices 22.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A dental radiographic scanning combination comprising:
(A) a dental prosthesis device having one or more artificial teeth supported by an artificial base, a part of the artificial base being capable of receiving a portion of a mouth of a patient;
(B) a radiopaque dental impression material being capable of creating a physical impression of the portion of the mouth of the patient, the radiopaque dental impression material removably attaches to the dental prosthesis device, the radiopaque dental impression material forms an impression by being sandwiched between the dental prosthesis device and the portion of the mouth of the patient; and
(C) a scanning device that performs a scan of the dental prosthesis device and the radiopaque dental material together to create a data file of an image of the dental prosthesis device and radiopaque dental material together.

2. The combination of claim 1 wherein the scan is an intraoral scan, the image further comprises the portion of the patient's mouth, the radiographic image further indicating that the radiopaque dental impression material is sandwiched between the portion of the mouth of the patient and the dental prosthesis device.

3. The combination of claim 1 wherein the application of the radiopaque dental impression material to the dental prosthesis device and a subsequent removal of the radiopaque dental impression material from the dental prosthesis device can occur without permanently altering the structure of the dental prosthesis device.

4. The combination of claim 1 wherein the radiopaque dental impression material comprises a material base selected from a group of dental material bases consisting silicone impression material, a silicone disclosing agent, a methacrylate-based reline material, zinc-oxide eugenol material.

5. The combination of claim 4 wherein the radiopaque dental impression material further comprises a radiopaque material selected from a group of radiopaque materials consisting aluminum, ytterbium, itrium, gadolinium, zirconium, strontium, tungsten, tantalum, niobium, bismuth, molybdenum lanthanum, barium.

6. The combination of claim 1 wherein an image formed from the data file discloses an opposing alveolar ridge that is not in contact with the dental prosthesis device.

7. The combination of claim 2 further comprising one or more non-radiopaque spacers that prevents one or more tissues not constituting the portion of the mouth of the patient's mouth from contacting the dental prosthesis device.

8. The combination of claim 1 wherein the data file is further processed by a computer system using DICOM software to create a virtual model of the dental impression material.

9. The combination of claim 2 wherein the data file can be further processed by a computer system using DICOM software to create a virtual model of the dental impression material, the, the dental prosthesis device and the portion of the mouth of the patient.

10. The combination of claim 8 wherein the virtual model of the dental impression material is used to create to create another data file that is used in a dental implement planning and manufacture.

11. The combination of claim 10 wherein the dental implement planning and manufacture creates a new dental prosthesis device that eliminates any unwanted voids between the dental prosthesis device and the portion of the mouth of the patient, the unwanted voids as being represented by the impression.

12. The combination of claim 10 wherein the dental implement planning and manufacture creates a filler that attaches to the dental prosthesis device that eliminates any unwanted voids between the dental prosthesis device and the portion of the mouth of the patient, the unwanted voids being represented by the formed impression.

13. A method of operating a scanning dental combination comprising the following steps, but not necessarily in the order shown:
(A) providing a prosthesis device having an artificial base supporting one or more artificial teeth;
(B) providing a radiopaque dental impression material that can form a physical impression of a portion of a mouth of patient, the portion of a mouth of a patient being used to support the dental prosthesis device;
(C) using the radiopaque dental impression material to make an impression of the portion of the mouth of the patient;
(D) forming a combination of the radiopaque dental impression material and dental prosthesis device; and
(E) scanning the combination with a radiographic scanning machine to create at least one digital file of a radiographic-based image of the combination.

14. The method of claim 13 comprising a step of radiographically scanning another combination intraorally to create at least one other digital file, the another combination comprising the radiographic dental impression material, the portion of the mouth of the patient and the dental prosthesis device, the radiographic dental impression material being sandwiched between the portion of the mouth of the patient and the dental prosthesis device.

15. The method of claim 14 further comprising a step of processing at least one digital file and the at least one other digital file by a computer system to create a virtual three dimension model of the impression as formed by the radiographic dental impression material.

16. The method of claim 15 further comprising a step of using the virtual three dimension model used to create data that is used in a dental implement planning and manufacture.

17. The method of claim 14 wherein the combination further comprises the portion of the mouth of the patient, the radiographic impression material being sandwiched between the portion of the mouth of the patient and the dental prosthesis device.

18. The method of claim 13 further comprising a step of processing the digital file by a computer system to create a virtual three dimension model of the impression formed by the radiographic dental impression material.

19. The method of claim 13 further comprising a step of the preventing the opposing alveolar ridge from contacting the dental prosthesis device to reduce the amount radiographic interference that can be generated by the opposing alveolar ridge upon a radiographic image of the dental prosthesis device.

20. The method of claim 13 further comprising a step of using at least one digital file to create the virtual three dimension model used to create data that is used in dental surgical planning.
